(19) United States
(12) Patent Application Publication
(10) Pub. No.: US 2002/0016819 A1
(43) Pub. Date: Feb. 7, 2002

(54) Content management server, server system and method of controlling operation thereof

(76) Inventors: Mika Sugimoto, Asaka-shi (JP); Sugio Makishima, Tokyo (JP); Norihisa Haneda, Asaka-shi (JP)

Correspondence Address: McGinn & Gibb, PLLC, Suite 200, 8321 Old Courthouse Road, Vienna, VA, 22182-3817, US

(21) Appl. No.: 09/908,555

(22) Filed: Jul. 20, 2001

(30) Foreign Application Priority Data
Jul. 31, 2000 (JP) 2000-230140

(51) Int. Cl. G06F 15/16

(52) U.S. Cl. 709/203; 709/217

(57) ABSTRACT

A Web page involving a small quantity of data is generated automatically by a content management server even though use is made of materials such as images involving a large quantity of data. Data representing an original image containing a large quantity of data is stored in a database of a content management server. The content management server generates a thumbnail image of the original image and creates a Web page utilizing the thumbnail image. A Web page containing the thumbnail image can be generated in the content management server even though it is not created by the user of the client computer. A file representing the generated Web page is stored on the hard disk of a Web page server. The Web page containing the thumbnail image can be viewed by accessing the Web page server.

### BACKGROUND OF THE INVENTION

1. Field of the Invention

This invention relates to a content management server, server system and method of controlling the operation thereof.

2. Description of the Related Art

When a Web page is produced, usually a program is written using HTML (HyperText Markup Language) in a client computer. This creates the source file of the Web page. The source file of the Web page is uploaded from the client computer to a server and is recorded on the server hard disk. The client computer may subsequently access the server, whereby the Web page conforming to the source file of the Web page that was uploaded to the server is displayed on the display unit of the client computer.

The area (capacity) of the server hard disk allocated to the user of the client computer is limited. This imposes a limitation upon the Web page that can be constructed using materials such as images and sounds that involve large quantities of data. Further, though communication efficiency has improved in recent years, the transmission of data for displaying a Web page, which contains materials having a large quantity of data, from a server to a client computer is inefficient.

### DISCLOSURE OF THE INVENTION

Accordingly, an object of the present invention is to make it possible to construct a Web page containing a small amount of data even if use is made of materials such as images and sounds that involve large quantities of data.

Another object of the present invention is to raise the communication efficiency of data representing a Web page.

According to a first aspect of the present invention, the foregoing objects are attained by providing a content management server that is capable of communicating with a client computer and a Web page server, comprising: a receiving unit for receiving original digital content transmitted from the client computer; a Web page data generating unit for generating data for displaying a Web page, which includes a first section for acquiring part of the original digital content received by the receiving unit, on a display unit of the client computer; and a Web page data transmitting unit for transmitting the Web page data, which has been generated by the Web page data generating unit, to at least one of the client computer and Web page server.

The first aspect of the present invention provides also an operation control method suited to the above-described content management server. Specifically, the first aspect of the invention provides a method of controlling the operation of a content management server that is capable of communicating with a client computer and a Web page server, comprising the steps of: receiving original digital content transmitted from the client computer; generating data for displaying a Web page, which includes a first section for acquiring part of the original digital content received, on a display unit of the client computer; and transmitting the generated Web page data to at least one of the client computer and Web page server.

In accordance with the first aspect of the present invention, original digital content (inclusive of image data representing images, sound data representing sounds and text data representing characters and text) is transmitted from a client computer to a content management server.

When the original digital content transmitted from the client computer is received by the content management server, the latter generates Web page data for displaying, on the display unit of the client computer, a Web page that includes a first section for acquiring part of the original digital content received. The generated Web page data is transmitted to at least one of the client computer and Web page server.

The Web page data includes a first section for obtaining part of the original data content. (If the original digital content is image data, the first section may be a thumbnail image represented by thumbnail image data constituting part of the image data.) The first section does not include the original image, etc., represented by the original digital content. As a result, the amount of Web page is reduced.

When the Web page generated by the content management server is transmitted to the Web page server, the data is stored on the hard disk of the Web page server.

The Web page data generated by the content management server is transmitted to the client computer, whereby it becomes possible for the user of the client computer to change the layout of the Web page. The Web page data whose layout has been changed is transmitted from the client computer to the Web page server, where the data is stored.

Since the amount of Web page data is small, this data can be stored at the Web page server even if the user area that has been allocated to the Web page server is small.

The user of the client computer accesses the Web page server when the user wishes to view his or her Web page. In response, the Web page data is transmitted to the client computer. As a result, the Web page represented by the Web page data is displayed on the display unit of the client computer that accessed the Web page server.

The original digital content transmitted from the client computer to the content management server preferably is stored at the content management server (in a storage device for original digital content). If necessary, the original digital content can be transmitted to the client computer that accessed the Web page server.

A second aspect of the present invention relates to a server system comprising a Web page server and a content management server capable of communicating with each other.

In this case, the Web page server has a first transmitting unit for transmitting, to the client computer, data for displaying a Web page that includes a first section for obtaining part of the original digital content and a second section for displaying a window that is for outputting the substance represented by the original digital content.

The content management server has a second transmitting unit which, in response to data transmitted from the client computer indicating that the second section has been clicked, transmits the original digital content to the client computer.

At least one of the Web page server and content management server has a third transmitting unit for transmitting part of the original digital content to the client computer in response to receipt of data transmitted from the client computer indicating that the first section has been clicked.

The Web page server and content management server may be constructed independently of each other.

The second aspect of the present invention provides also an operation control method suited to the above-described server system. Specifically, the first aspect of the invention provides a method of controlling the operation of a server system comprising a Web page server and a content management server capable of communicating with each other. The method includes transmitting, from the Web page server to the client computer, data for displaying a Web page that includes a first section for obtaining part of original digital content and a second section for displaying a window that is for outputting the substance represented by the original digital content. The content management server transmits the original digital content to the client computer in response to data transmitted from the client computer indicating that the second section has been clicked. At least one of the Web page server and content management server transmits part of the original digital content to the client computer in response to receipt of data transmitted from the client computer indicating that the first section has been clicked.

In accordance with the second aspect of the present invention, when the client computer accesses the Web page server, the Web page server sends the client computer data for display a Web page that includes a first section for obtaining part of original digital content and a second section for displaying a window that is for outputting the substance represented by the original digital content. When this is done, the Web page represented by the data transmitted from the Web page server is displayed on the client computer.

If the first section in the Web page is clicked by the user of the client computer, the data indicative of this fact is transmitted from the client computer to the Web page server or content management server. Upon receiving the data indicative of clicking of the first section, the Web page server or content management server transmits part of the original digital content to this client computer. If the original digital content is image data, data representing a thumbnail image would be transmitted to the client computer; if sound data, part of this would be transmitted to the client computer; and if text data, then part of this text or text data representing a summary thereof would be transmitted to the client computer.

Owing to part of the original digital content being received by the client computer, the user of the client computer can ascertain the substance of the original digital content. In a case where the user of the client computer wishes to acquire the original digital content upon ascertaining the substance thereof, the user of the client computer clicks the second section. When this is done, the data indicative of clicking is transmitted to the content management server.

If data indicating that the second section has been clicked is received by the content management server, the original digital content is transmitted from the content management server to the client computer. The latter outputs images, sound and text, etc., represented by the digital content.

It goes without saying that part of the original digital content has been stored at the Web page server or content management server, and that the original digital content has been stored at the content management server. (In other words, the Web page server is provided with a storage unit for storing original digital content, and the content management server is provided with a storage unit for storing the original digital content.)

Thus the user of the client computer is capable of checking part of the original digital content as well as the overall substance thereof.

The content management server further includes a fourth transmitting unit, which is responsive to receipt of data transmitted from the client computer indicating that the second section has been clicked, for transmitting, to the client computer, data for displaying, on a display unit, a window containing an order area for ordering a printout of the original digital content.

In response to clicking of the second section at the client computer, data for displaying a window containing an order area is transmitted from the content management server to the client computer. The window containing the order area is displayed on the display unit of the client computer. The user of the client computer can order a printout of the digital content by clicking the order area on the displayed window.

The content management server further includes a fifth transmitting unit, which is responsive to receipt of data transmitted from the client computer indicating that the order area has been clicked, for transmitting, to the client computer, data for displaying a window for inputting order information.

In response to clicking of the order area at the client computer, data for displaying a window for inputting order information is transmitted from the content management server to the client computer. The window for inputting order information is displayed at the client computer. The user of the client computer can input information for ordering a printout of the original digital content (user name, mailing address, method of accepting printout and method of payment, etc.) by inputting order information in accordance with the displayed window. The order information that has been input is transmitted from the client computer to the content management server.

In accordance with the order information that has been transmitted from the client computer, the content management server delivers the printout to the user.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a diagram showing the configuration of a digital content ordering system;

FIG. 2 is a flowchart illustrating image registration processing;

FIGS. 3 and 4 show examples of windows displayed on a display unit of a client computer;

FIG. 5 is a flowchart illustrating processing for creating a Web page;

FIGS. 6 to 8 show examples of windows displayed on a display unit of a client computer;

FIGS. 9 and 10 are flowcharts illustrating print ordering processing;

FIGS. 11 to 14 show examples of windows displayed on a display unit of a client computer.

### DESCRIPTION OF THE PREFERRED EMBODIMENT

A preferred embodiment of the present invention will now be described with reference to the drawings.

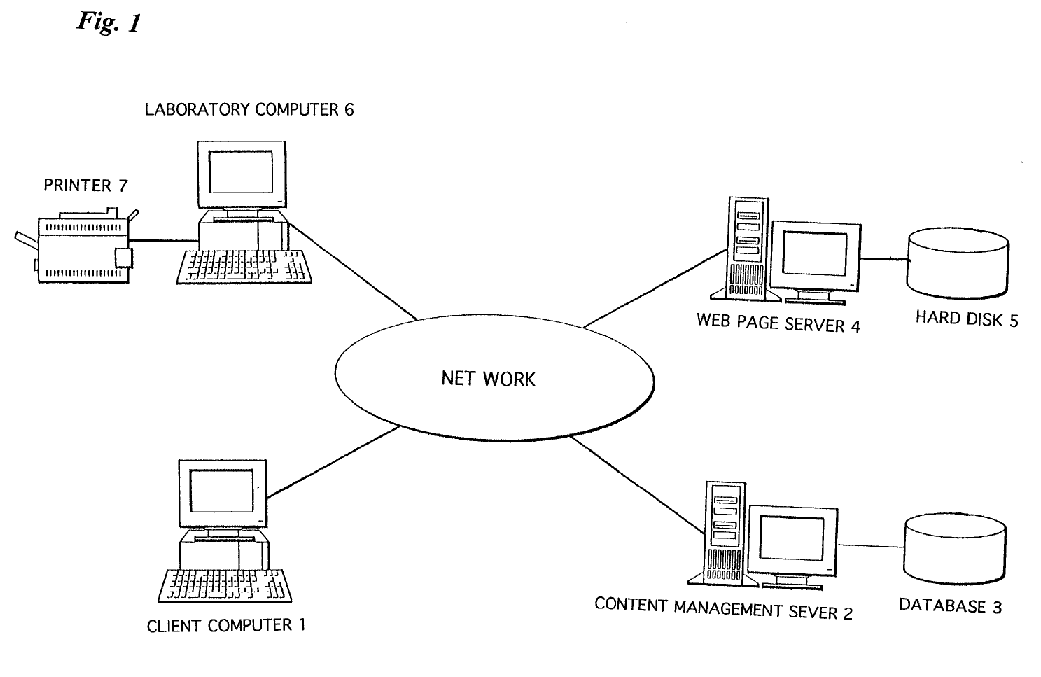

FIG. 1 illustrates the configuration of a digital content ordering system according to a preferred embodiment of the invention.

The digital content ordering system comprises a client computer 1, a content management server 2, a Web page server 4 and a laboratory computer 6 that are capable of communicating with one another via a network. Though only one client computer 1 and one laboratory computer 6 are shown in FIG. 1, it goes without saying that a number of client computers and a number of laboratory computers would be connected to the network.

It goes without saying that the client computer 1, content management server 2, Web page server 4 and laboratory computer 6 are each provided with a modem for sending and receiving digital data, a memory for storing digital and other data temporarily, a CPU, a keyboard and a mouse, etc. These would also be provided with a floppy-disk drive and a CD-ROM (Compact Disk Read-Only Memory), etc., as necessary.

A database 3 is connected to the content management server 2. As will be described later, image data (digital content) representing an ordinary image that has been uploaded from the client computer 1 is stored in the database 3.

A hard disk 5 is connected to the Web page server 4. Stored on the hard disk 5 are an ID for identifying original image data that has been uploaded to the content management server 2, attribute information such as the date on which original image data was registered with the content management server 2, and a Web page file for displaying a Web page, etc.

A high-resolution printer 7 for printing images is connected to the laboratory computer 6.

In the digital content ordering system according to this embodiment, original image data is uploaded from the client computer 1 to the content management server 2. The latter generates thumbnail image data representing the thumbnail image of an original image represented by the original image data.

Thumbnail image data that has been generated is transmitted to the Web page server 4. The latter stores the received thumbnail image data on the hard disk 5. Further, the content management server 2 generates a Web page file for displaying a Web page. The generated Web page file also is transmitted from the content management server 2 to the Web page server 4. The Web page file received by the Web page server 4 is stored on the hard disk 5.

By accessing the Web page server 4, the client computer 1 reads out the Web page file and thumbnail image data that have been stored on the hard disk 5 of the Web page server 4. The Web page file and thumbnail image data that have been read out are transmitted from the Web page server 4 to the client computer 1. As a result, the Web page containing the thumbnail image is displayed on the display screen of the display unit of client computer 1.

A servelet and a JSP (Java Server Pages) file can be utilized to generate a Web page that contains an image. A servelet executes a program in association with the Web page server 4 and generates a JSP file that contains the result of executing this program. A JSP embeds a specific tag in the HTML that creates the Web page and communicates with Java program or a servelet. The servelet and JSP file are stored on the Web page server 4.

A thumbnail image constructing a displayed Web page is linked to the original image data that has been stored on the database 3 of the content management server 2. If a thumbnail image constructing a Web page is clicked by the user of the client computer 1, therefore, the original image data stored on the database 3 of content management server 2 is read out. The original image data read out is transmitted from the content management server 2 to the client computer 1. Thus, the original image is displayed on the display screen of the display unit of client computer 1. (The displayed image may be one having a resolution higher than that of the thumbnail image but lower than that of the original image.)

Furthermore, a print of the original image can be ordered in this embodiment. If data representing an order for an original image is transmitted from the client computer 1 to the Web page server 4, the latter transmits data representing the order to the laboratory computer 6. The latter requests transmission of the original image data that has been stored in the database 3 of content management server 2. In response, the content management server 2 reads the original image data out of the database 3 and transmits it to the laboratory computer 6. The original image data received by the laboratory computer 6 is applied to the printer 7, which proceed to print out the data.

The content ordering system will be understood in greater detail from the description that follows.

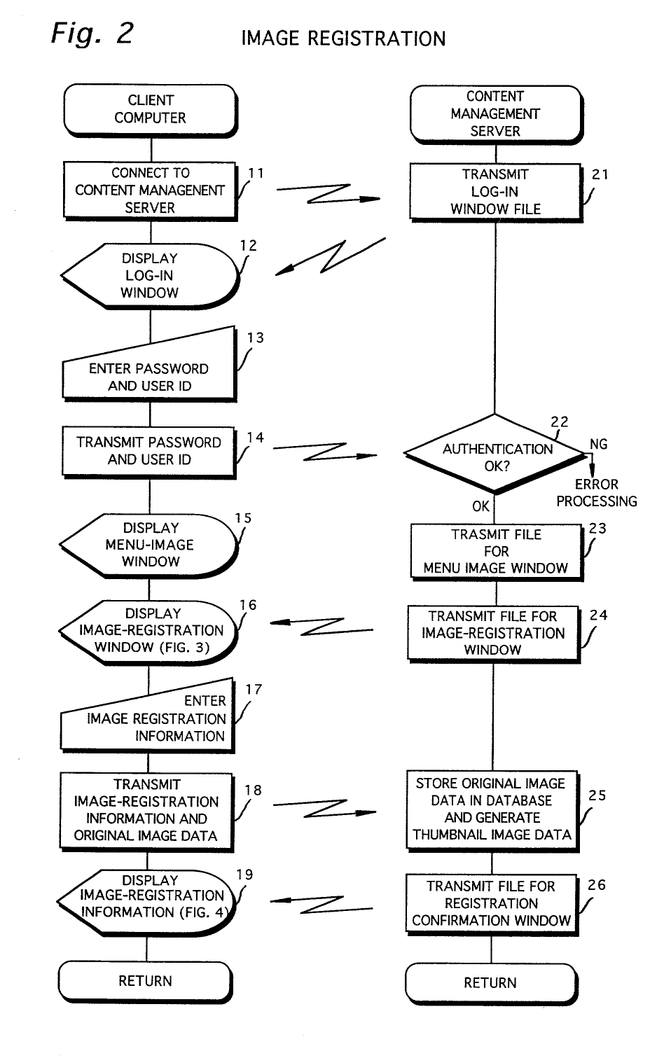

FIG. 2 illustrates processing (image registration processing) for storing original image data in the database 3 of content management server 2.

First, the client computer 1 accesses the content management server 2 and is connected to the content management server 2 (step 11). When this is done, a log-in window file for displaying a log-in window is transmitted from the content management server 2 to the client computer 1 (step 21).

When the client computer 1 receives the log-in file transmitted from the content management server 2, the log-in window (not shown) is displayed on the display screen of the display unit of client computer 1 (step 12). The log-in window includes an area for entering a password and user ID. The user of the client computer 1 enters the password and user ID in accordance with the log-in window (step 13). Data indicative of the password and user ID entered by the user of the client computer 1 is transmitted from the client computer 1 to the content management server 2 (step 14).

Upon receiving the password and user ID transmitted from the client computer 1, the content management server 2 executes user authentication processing based upon the received password and user ID (step 22). If the result of authentication is that the user is authorized (“OK” at step 22), a file for displaying a menu image window is transmitted from the content management server 2 to the client computer 1 (step 23). If it is found as the result of authentication that the user is not authorized (“NG” at step 22), predetermined error processing is executed. It goes without saying that the ID of a user who is capable of utilizing the content management server 2 is stored in the content management server 2 beforehand and that authentication processing is executed based upon whether the stored user ID matches the user ID transmitted from the client computer 1.

When the menu-image window file transmitted from the content management server 2 is received by the client computer 1, a menu-image window (not shown) is displayed on the display unit of the client computer 1 (step 15). The menu-image window has an area for selecting image registration and an area for selecting a list-display of original images that have been registered with the content management server 2. Assume that image registration has been selected. When image registration is selected, a file for displaying an image-registration window is transmitted from the content management server 2 to the client computer 1 (step 24).

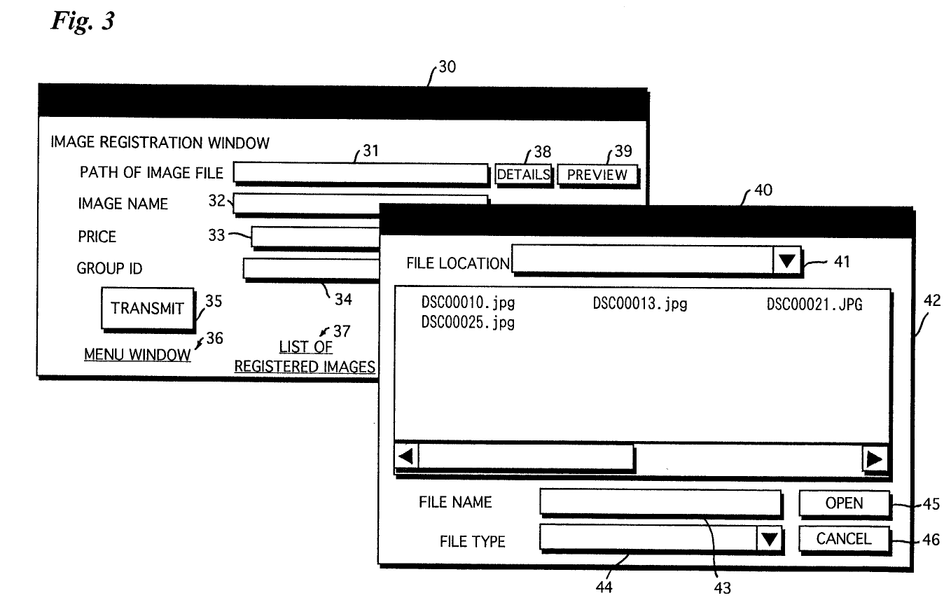

When the image-registration window file transmitted from the content management server 2 is received by the client computer 1, an image-registration window 30, which is shown in FIG. 3, is displayed on the display screen of the display unit of client computer 1 (step 16).

The image-registration window 30 includes the following areas:

Image-file path area 31:

This is an area for displaying the path of original image data to be stored in the database 3 of content management server 2.

Image-name area 32:

This is an area that displays the image name of an original image represented by original image data. A name different from the image file name of the original image can be assigned.

Price area 33:

The ordering system according to this embodiment is such that when another person prints an original image, a fee is paid to the owner of the original image. The price area 33 displays the price.

Group ID area 34:

In the ordering system according to this embodiment, only a user acknowledged by the owner of an original image is allowed to print the original image. A user acknowledged by the owner of an original image is taught a group ID by the owner of the original image. The group ID area 34 displays the group ID entered by the user.

Transmit area 35:

This area is clicked by the user when data representing the path, image name, price and group ID of an image file entered by the user of the client computer 1 is transmitted from the client computer 1 to the content management server 2.

Menu-window area 36:

This is an area clicked when a menu-image window is displayed on the display screen of the display unit of client computer 1.

Registered-image list area 37:

This is an area which the user accessing the content management server 2 clicks when original images represented by original image data registered with the content management server 2 are to be displayed in list form.

Details area 38:

A file selection window 40, described below, appears on the display screen in response to clicking of this area.

Preview area 39:

An image represented by image data specified by the path being displayed in the image-file path area 31 is displayed on the display screen of the display unit by clicking this area.

The file selection window 40 includes the following areas:

File location area 41:

This area displays the folder name of a folder containing files.

File-name-list display area 42:

This area displays a list of file names of files contained in the selected folder.

File-name display area 43:

This area displays the selected file name.

File-type display area 44:

This is an area for specifying the type of a file having a file name displayed in the file-name-list display area 42.

Open area 45:

The file specified by the file name displayed in the file-name display area 43 is opened by clicked this area.

Cancel area 46:

The file selection window 40 is closed by clicking this area.

In any case, when image registration information composed of an image-file path, image name, group name, price and group ID is entered (step 17), the data representing the entered image registration information and the original image data that has been stored in the storage location specified by the image-file path is transmitted from the client computer 1 to the content management server 2 (step 18).

When the data representing the entered image registration information and the original image data transmitted from the client computer 1 is received by the content management server 2, the original image data is stored in the database 3 (step 25). Further, thumbnail image data representing a thumbnail image of the original image expressed by the original image data is generated at step 25. When this is done, a file for displaying a registration confirmation window is transmitted from the content management server 2 to the client computer 1 (step 26).

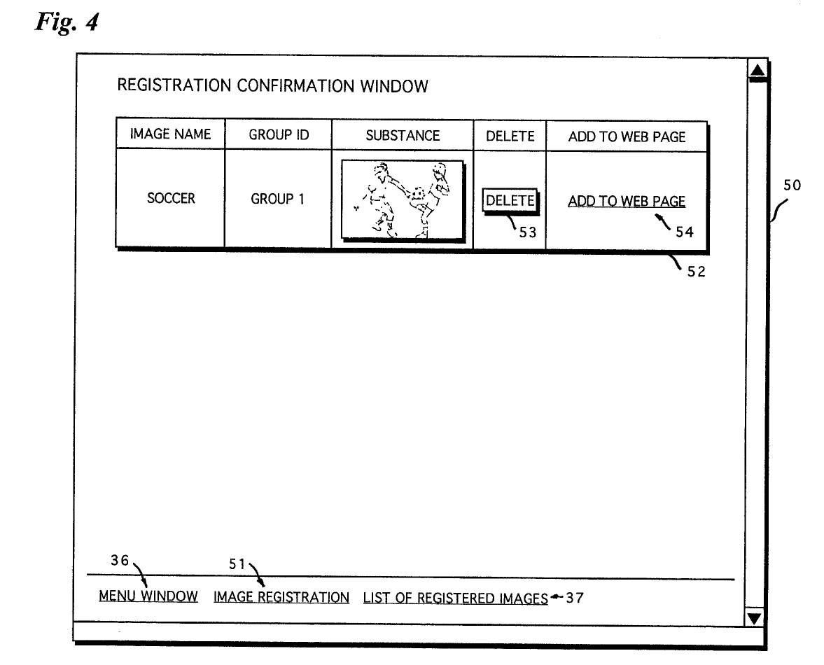

When the file for displaying the registration confirmation window transmitted from the content management server 2 is received by the client computer 1, a registration confirmation window 50 of the kind shown in FIG. 4 is displayed on the display screen of the display unit of client computer 1 (step 19).

The registration confirmation window 50 is for checking the content of the original image data that has been stored in the database 3 of content management server 2. The registration confirmation window 50 includes the following areas:

Registration-substance confirmation area 52:

This area includes the image name, group name and substance (thumbnail image) of an original image represented by original image data that has been stored in the database 3 of content management server 2, a delete area 53 and an area 54 for making additions to the Web page. Original image data that has been stored in the database 3 is deleted by clicking the delete area 53. By clicking the area 54, a thumbnail image represented by thumbnail image data of an original image that has been stored in the database 3 becomes an image constituting the Web page, described later.

Image registration area 51:

Clicking this area causes the image registration window shown in FIG. 3 to be displayed on the display screen of the display unit of client computer 1.

Furthermore, the registration conformation window also includes a menu window area 36 and the registered-image list area 37.

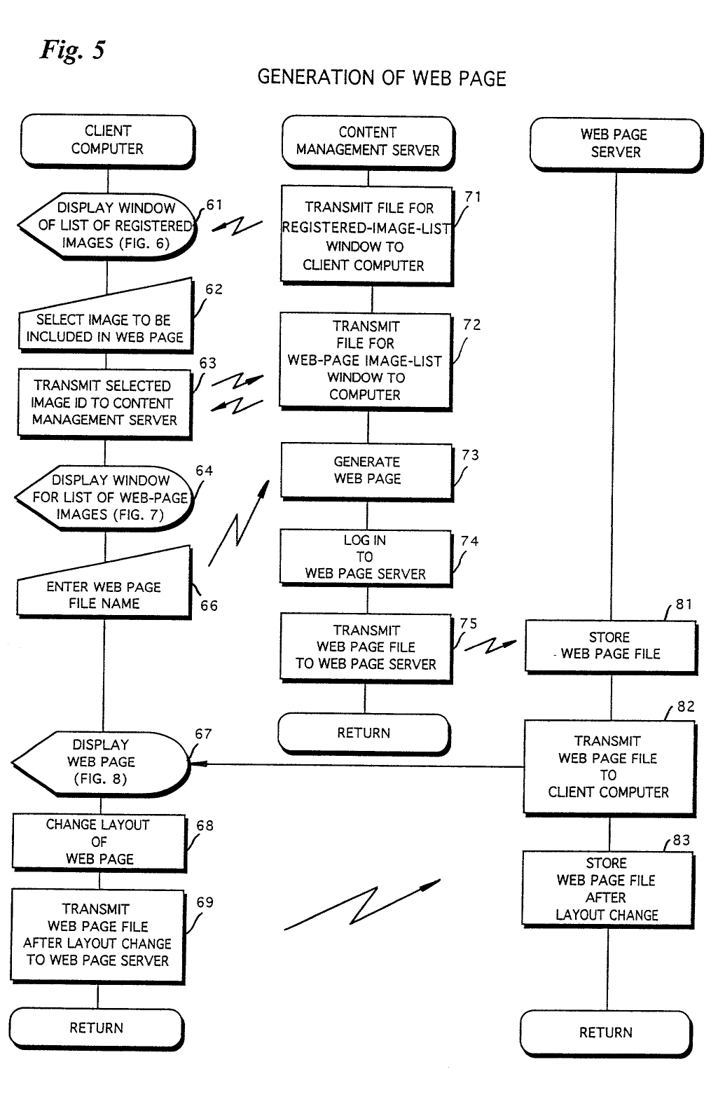

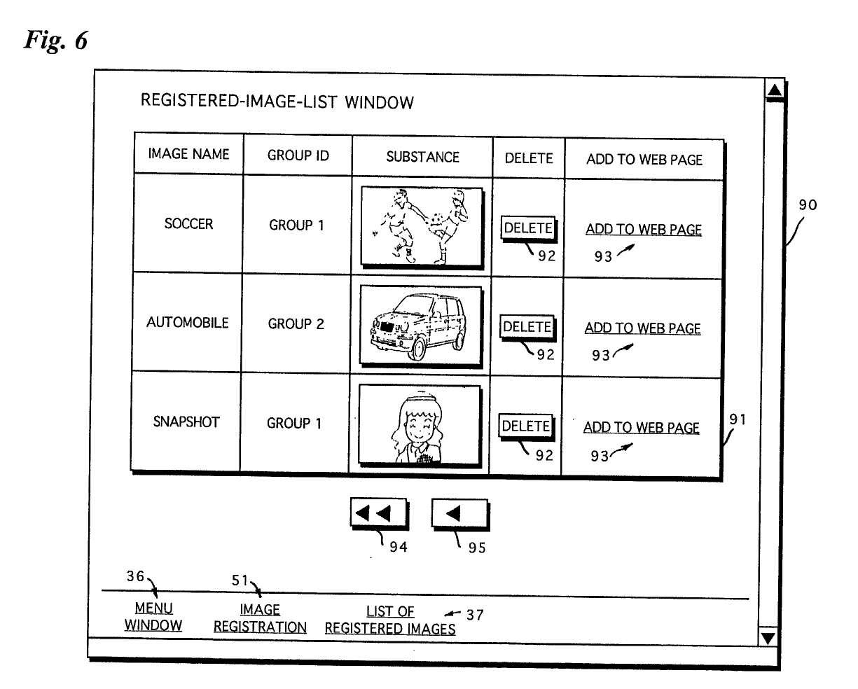

FIG. 5 is a flowchart illustrating processing for generating a Web page, and FIGS. 6 to 8 illustrate examples of windows displayed on the display screen of the display unit of client computer 1.

As mentioned above, it will be assumed here that the client computer 1 is accessing the content management server 2 and checking for user authentication.

If the registered-image list area 37 in the menu window, image-registration window 30 and registration confirmation window 50 is clicked by the user of the client computer 1, as described above, a registered-image-list window file is transmitted from the content management server 2 to the client computer 1 (step 71).

When the client computer 1 receives the registered-image-list window file, a registered-image-list window 90 shown in FIG. 6 is displayed on the display unit (step 61). The registered-image-list window 90 displays, in the form of a list, the contents of original images represented by the original image data that has been stored in the database 3 of the content management server 2 in order that the user of the client computer 1 may check the contents of these images. The registered-image-list window 90 includes the following areas:

Recorded-image-list area 91:

The image names, group IDs, content (thumbnail images), delete areas 92 and Web-page-addition areas 93 of original images represented by the original image data that has been stored in the database 3 are displayed in association with the number of registered original images. Clicking a delete area 92 deletes the corresponding original image data from the database 3. Clicking the Web-page-addition area 93 adds a thumbnail image of the corresponding original image as an image constituting the Web page of this user.

Top-page designation area 94:

This is an area clicked by the user when the top page is to be displayed in a case where registered images extend over a plurality of pages.

Previous-page designation area 95:

This is an area clicked by the user when the page preceding the presently displayed page is to be displayed in a case where registered images extend over a plurality of pages.

The registered-image-list window 90 further includes the menu-window area 36, the image registration area 51 and the registered-image list area 37.

The user of the client computer 1 selects an image to be added to the Web page of this user (step 62). More specifically, among the Web-page-addition areas 93, a Web-page-addition area 93 corresponding to the image to be added to the Web page is clicked in the manner described above. When this is done, data (generated by the content management server 2) indicating the image ID for specifying the image is transmitted from the client computer 1 to the content management server 2 (step 63).

When the image ID data transmitted from the client computer 1 is received by the content management server 2, the latter sends the client computer 1 a file for displaying an image-registration-list window that includes the thumbnail image specified by this image ID (step 72). It goes without saying that the file for this image-registration-list window is specific to the user who transmitted the image ID data.

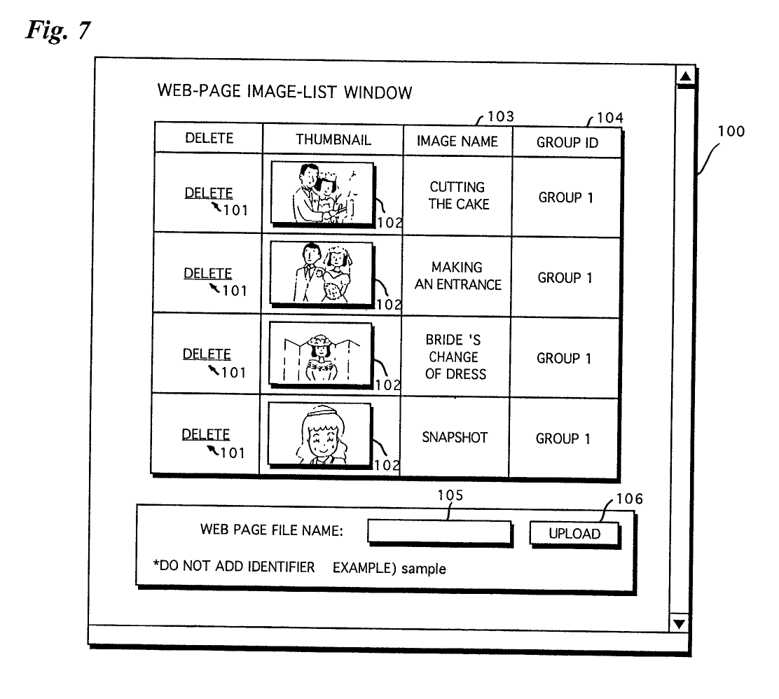

When the file for the image-registration-list window transmitted from the content management server 2 is received by the client computer 1, a Web-page image-list window 100 shown in FIG. 7 is displayed on the display screen of the display unit (step 64). The Web-page image-list window 100 displays, in list form, the images constituting the Web page of the user. This window includes the following areas:

Delete area 101:

This is an area clicked by the user when the corresponding thumbnail image is to be deleted from the Web page.

Thumbnail-image display area 102:

This is an area for displaying a thumbnail image constituting the Web page.

Image-name display area 103:

This is an area for displaying the names of images being displayed in the thumbnail-image display areas 102.

Group-ID display area 104:

This is an area for displaying the group IDs of images being displayed in the thumbnail-image display area 102.

Web page file-name display area 105:

This is an area for displaying the file name of the Web page. It displays a file name entered by the user of the client computer 1.

Upload area 106:

Clicking this area causes the data representing the image IDs to be transmitted to the content management server 2 together with the data representing the file name entered by the user, in such a manner that the thumbnail images being displayed in the Web-page image-list window 100 will construct the Web page.

The Web page file name is entered by the user of the client computer 1 (step 65). If the upload area 106 is clicked, the data representing the image IDs is transmitted to the content management server 2 together with the data representing the file name entered by the user, in such a manner that the thumbnail images being displayed in the Web-page image-list window 100 will construct the Web page (step 66).

When the data representing the file name, etc., transmitted from the client computer 1 is received by the content management server 2, a file representing the Web page that includes the thumbnail images is generated so as to have this file name (step 73). The content management server 2 logs into the Web page server 4 (step 74) and the generated Web page file is transmitted to the Web page server 4 (step 75).

When the Web page file is received by the Web page server 4, it is stored on the hard disk 5 (step 81).

If the client computer 1 accesses the Web page server 4 and an URL (Uniform Resource Locator) is entered the client computer 1, the Web page file specified by the entered URL is read from the hard disk 5. The read Web page file is transmitted from the Web page server 4 to the client computer 1 (step 82).

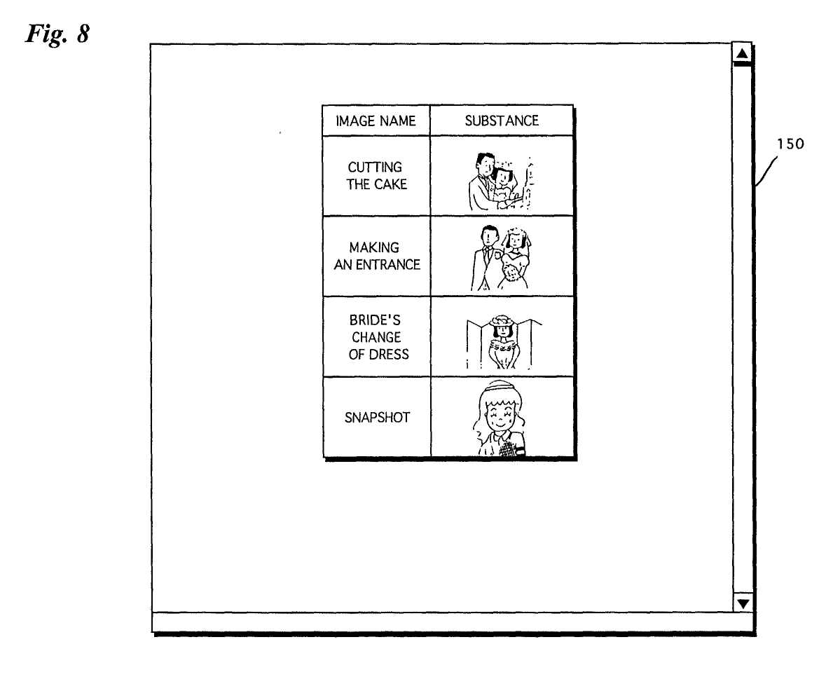

When the Web page file transmitted from the Web page server 4 is received by the client computer 1, the Web page represented by the Web page file is displayed on the display unit (step 67; see FIG. 8). It goes without saying that this Web page contains the thumbnail images selected as set forth above. Thus, a Web page having a prescribed layout can be generated merely by selecting images. Even a user not accustomed the creation of a Web page can generate a Web page comparatively simply.

The user of the client computer 1 can alter the layout of the Web page by changing the content of the Web page file transmitted from the Web page server 4 (step 68). If the layout is altered, the Web page file representing the Web page having the altered layout is transmitted from the client computer 1 to the Web page server 4 (step 69).

When the Web page file of changed layout transmitted from the client computer 1 is received by the Web page server 4, the file is stored on the hard disk 5 (step 83). In response to the client computer 1 accessing the Web page server 4, the Web page of altered layout is displayed.

In this embodiment, a Web page file is transmitted from the content management server 2 to the Web page server 4. However, an arrangement may be adopted in which the file is transmitted from the content management server 2 to the client computer 1.

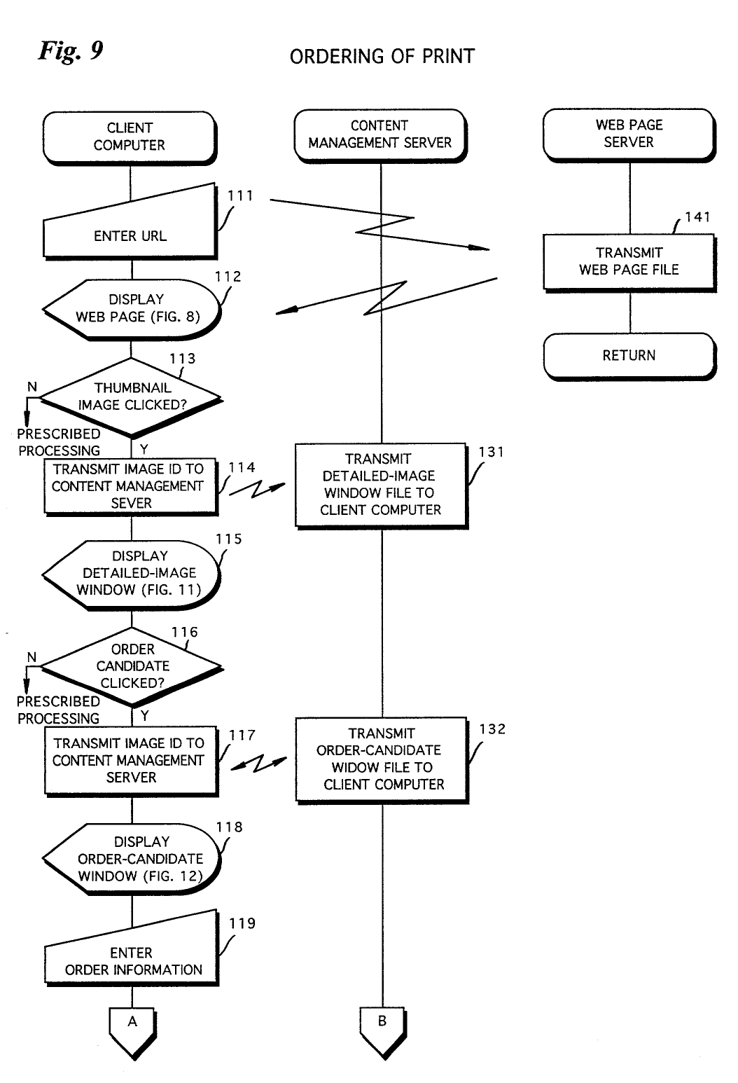

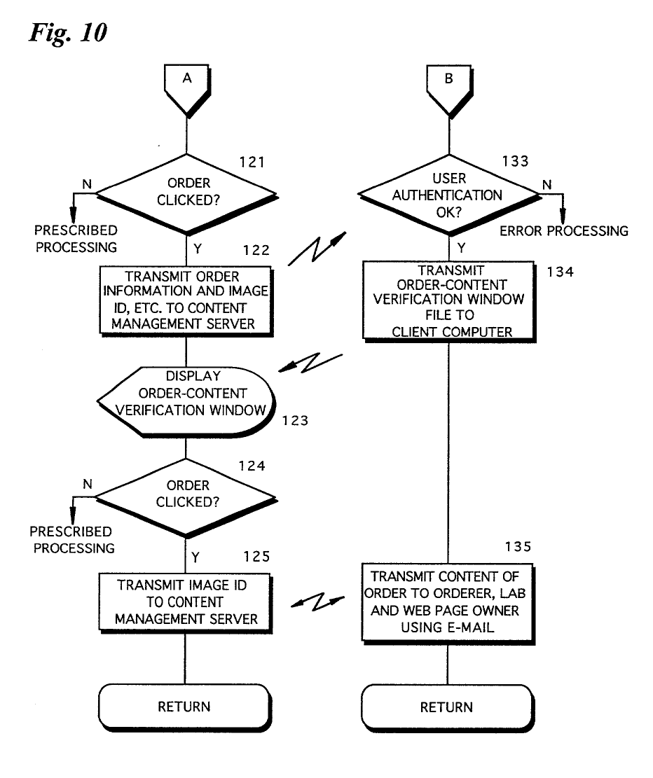

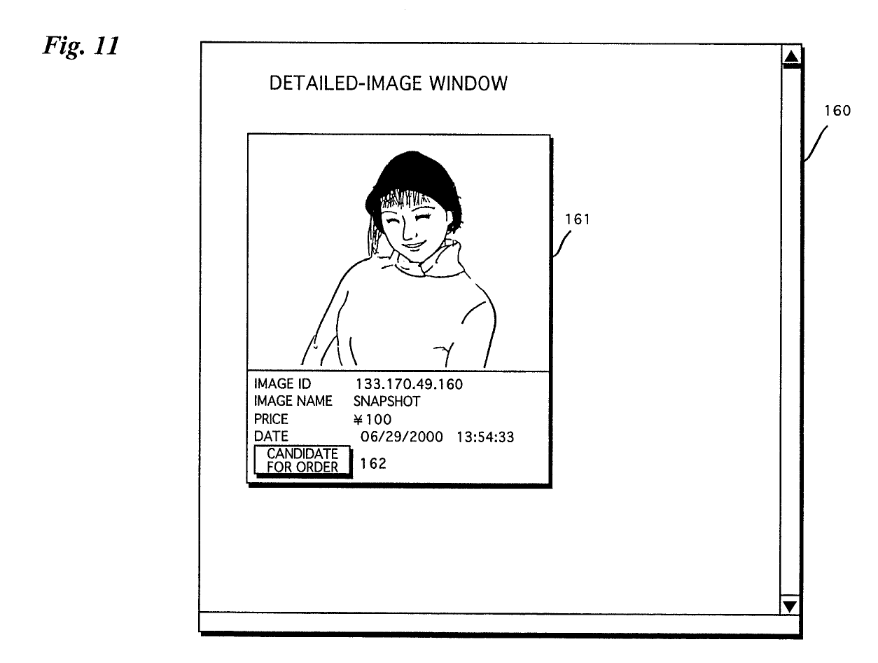

FIGS. 9 and 10 are flowcharts illustrating processing for ordering a print, and FIGS. 11 to 13 are diagrams showing examples of windows displayed on the display unit of the client computer.

A user who orders a print enters the URL of the Web page using the client computer 1 (step 111). The data representing the URL is transmitted from the client computer 1 to the Web page server 4.

The Web page file that has been stored in the area designated by the URL specified by the transmitted URL data is read from the hard disk 5 at the Web page server 4. The Web page file thus read is transmitted from the Web page server 4 to the client computer 1 (step 141).

When the Web page file transmitted from the Web page server 4 is received by the client computer 1, the Web page (see FIG. 8) represented by this Web page file is displayed on the display screen of the display unit (step 112). If a thumbnail image constituting the Web page is clicked by the user of the client computer 1 (“YES” at step 113), then the image ID corresponding to the clicked thumbnail image is transmitted from the client computer 1 to the content management server 2 (step 131).

When the image ID data transmitted from the client computer 1 is received by the content management server 2, the latter sends the client computer 1 a detailed-image window file that is capable of representing the detailed image having the image ID specified by the image ID data (step 131). (As mentioned above, the detailed image may be the original image or an image having a resolution lower than that of the original image but higher than that of the thumbnail image. It goes without saying that if the detailed image is different from the original image, then the image would be generated by the content management server 2.)

When the detailed-image window file transmitted from the content management server 2 is received by the client computer 1, a detailed-image window 160 of the kind shown in FIG. 11 is displayed on the display unit (step 115). The detailed-image window 160 includes the following areas:

Detailed-image display area 161:

This area displays the detailed image. As mentioned above, the detailed image has a resolution higher than that of the thumbnail image and therefore detailed portions of the image can be checked. The detailed-image display area includes the image ID of the original image corresponding to the detailed image, the image name of the original image, the price of the original image, the date on which the original image was stored in the database 3 of the content management server 2, and an order-candidate area 162.

The order-candidate area 162 is clicked by the user if the original image corresponding to the detailed image is to be made a candidate for printing by a laboratory and purchase. If the order-candidate area 162 is clicked, image ID data of the original image corresponding to the detailed image being displayed in the detailed-image display area 161 is transmitted from the client computer 1 to the content management server 2 (step 117).

When the image ID data transmitted from the client computer 1 is received by the content management server 2, the latter sends the client computer 1 a file for displaying an order-candidate window that includes, as an order candidate, the original image having the image ID indicated by the received image ID data (step 132).

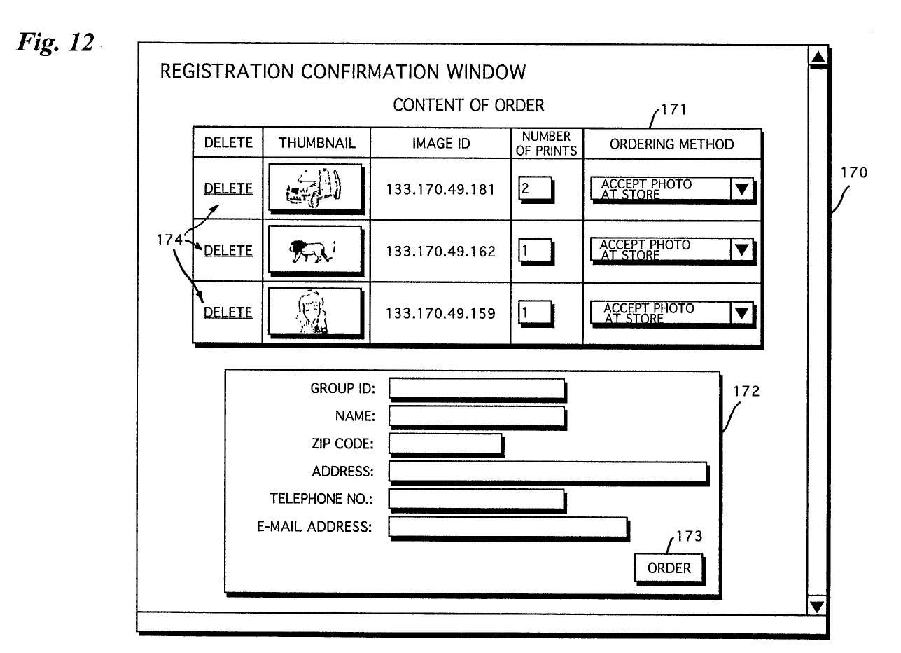

When the file for the order-candidate window transmitted from the content management server 2 is received by the client computer 1, an order-candidate window 170 shown in FIG. 12 is displayed on the display screen of the display unit (step 118). The order-candidate window 170 includes the following areas:

Order-content display area 171:

This is an area which displays the content of an order to print an image. More specifically, the thumbnail image corresponding to an original image to be printed, image ID, number of prints and print acceptance method are displayed. It goes without saying that the number of prints and acceptance method are designated by the user and the specifics designated are displayed. Also included is a delete area 174 corresponding to each thumbnail image. The order to print an image that has been made a candidate is canceled by clicking the delete area 174.

Orderer-information display area 172:

This is an area for displaying information relating to an entered orderer. More specifically, a group ID (taught by the owner of the Web page, as mentioned above), name, zip code, address, telephone number and e-mail address are displayed. An order information area 173 also is included. By clicking this area, data representing the entered order information and orderer information is transmitted from the client computer 1 to the content management server 2.

When order information and orderer information is entered by the user of the client computer 1 (step 119) and the order area 173 is clicked (“YES” at step 121), the order information, orderer information and data representing the image ID of the original image to be printed are transmitted from the client computer 1 to the content management server 2 (step 122).

Authentication processing is executed utilizing the user ID contained in the data transmitted from the client computer 1 (step 133). If the group ID is appropriate (“YES” at step 133), a file for displaying a window for checking the content of the order is transmitted from the content management server 2 to the client computer 1 (step 134).

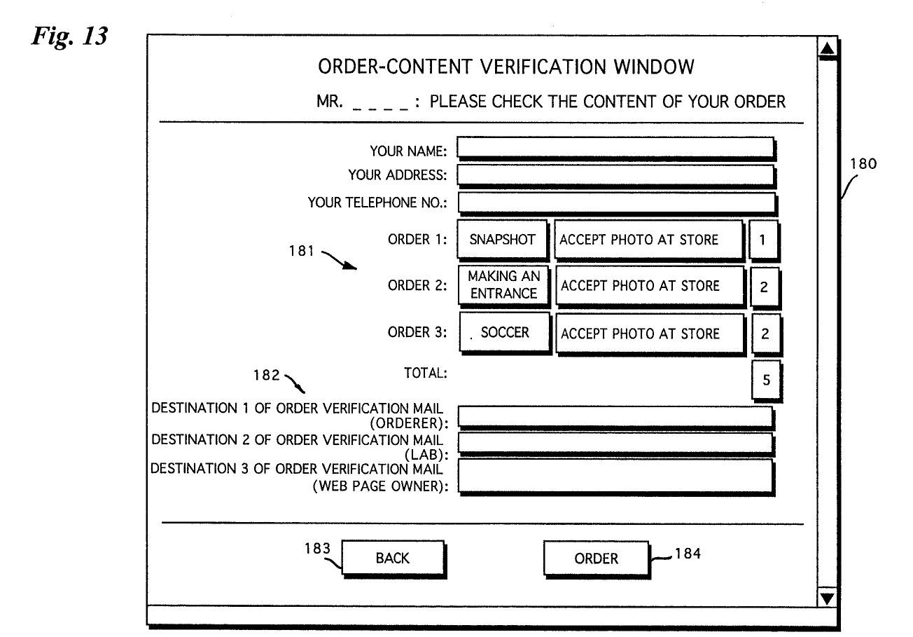

When the file transmitted from the content management server 2 for checking the specifics of the order is received by the client computer 1, an order-content confirmation window 180 of the kind shown in FIG. 13 is displayed on the display screen of the display unit (step 123). The order-content confirmation window 180 includes the following areas:

Order-content display area 181:

This is an area for displaying the content ordered by the user of the client computer 1. Specifically, the name of the orderer, the address of the orderer, the telephone number of the orderer, the image name of the ordered image, the method of accepting prints and the number of prints are displayed.

Order-confirmation mail display area 182:

In this embodiment, the content displayed in the order-content display area 181 is sent to the orderer, the laboratory and the owner of the original image to be printed (namely the owner of the Web page) using e-mail. The e-mail addresses that are the destinations are displayed.

Back area 183:

Clicking this area causes the order-candidate window shown in FIG. 12 to be displayed.

Order-area 184:

This area is clicked when an order is placed based upon the content displayed in the order-content display area 181.

If the order-area 184 is clicked by the user of the client computer 1 (“YES” at step 124), the image ID data of the original image to be printed and the order information for this image are transmitted from the client computer 1 to the content management server 2 (step 125).

When the image ID data and order information transmitted from the client computer 1 are received by the content management server 2, the content of the order is transmitted by e-mail to the designated orderer, laboratory and Web-page owner (step 135).

When the computer 6 of the laboratory receives the e-mail indicating the content of the order from the content management server 2, the computer 6 reads the image ID data contained in the content of the order. This image ID data is transmitted from the laboratory computer 6 to the content management server 2 and the original image data specified by the image ID is read from the database 3. The read image data of the original image is transmitted from the content management server 2 to the laboratory computer 6. The original image is printed by the printer 7 connected to the laboratory computer 6. The print produced by the printer 7 is accepted in accordance with the acceptance method designated by the orderer.

Thus, the ordering of an image print can be performed comparatively easily.

In the foregoing embodiment, a case is described in which image data is uploaded from the client computer 1 to the content management server 2. With this embodiment, however, not only image data but also data representing sounds (music) and text data representing characters and text can be uploaded from the client computer 1 to the content management server 2.

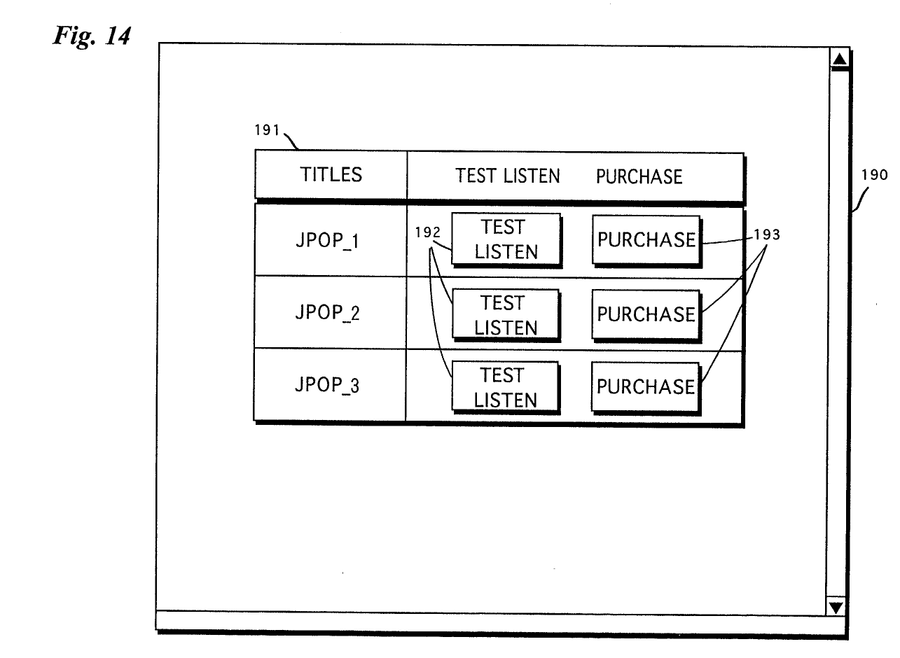

FIG. 14 illustrates a window (Web page) displayed on the display screen of the display unit of client computer 1 when a medium having music data recorded thereon is purchased in a case where the music data has been uploaded to the content management server 2.

This window includes an area 191 for displaying titles represented music data stored in the database 3 of content management server 2. The area 191 includes test-listen areas 192 and purchase areas 193 corresponding to the titles.

In response to clicking of a test-listen area 192 by the user, some of the original music data (data for outputting all of the music of one song) stored in the database 3 is transmitted from the content management server 2 to the client computer 1. When some of the data of the music transmitted from the content management server 2 is received by the client computer 1, a segment of the music can be listened to as a demonstration.

When the medium having the music recorded thereon is to be purchased as a result of the test-listening, the corresponding purchase area is clicked. When this is done, the order-candidate window shown in FIG. 12 is displayed and the content of the order is entered in the manner described above. Clicking the order area causes the order-confirmation window to be displayed so that the content of the order may be checked. Clicking the order area causes the order to placed. In a manner similar to that when an image is printed, the content of the order is transmitted to the distributor using e-mail and the music data that has been stored in the database 3 is downloaded and stored on a recording medium by the distributor. This recording medium is sold to the user by the distributor.

Even if digital data that has been uploaded to the content management server 2 is text data, the essence of the text represented by the text data can be viewed by clicking an area equivalent to the test-list area in a manner similar to that set forth above. If the user finds the essence of the text acceptable, then the user would click a purchase area to purchase a medium on which all of the text represented by the text data has been stored.

As many apparently widely different embodiments of the present invention can be made without departing from the spirit and scope thereof, it is to be understood that the invention is not limited to the specific embodiments thereof except as defined in the appended claims.

What is claimed is:

1. A content management server that is capable of communicating with a client computer and a Web page server, comprising:
a receiving unit for receiving original digital content transmitted from the client computer;
a Web page data generating unit for generating data for displaying a Web page, which includes a first section for acquiring part of the original digital content received by said receiving unit, on a display unit of the client computer; and
a Web page data transmitting unit for transmitting the Web page data, which has been generated by said Web page data generating unit, to at least one of the client computer and Web page server.

2. A server system comprising a Web page server and a content management server capable of communicating with each other, wherein:
said Web page server has a first transmitting unit for transmitting, to said client computer, data for displaying a Web page that includes a first section for obtaining part of the original digital content and a second section for displaying a window that is for outputting substance represented by the original digital content; and
said content management server has a second transmitting unit which, in response to data transmitted from said client computer indicating that the second section has been clicked, transmits the original digital content to said client computer; and
at least one of said Web page server and said content management server has a third transmitting unit for transmitting part of the original digital content to said-client computer in response to receipt of data transmitted from said client computer indicating that the first section has been clicked.

3. The system according to claim 2, wherein said content management server has a fourth transmitting unit, which is responsive to receipt of data transmitted from said client computer indicating that the second section has been clicked, for transmitting, to said client computer, data for displaying, on a display unit, a window containing an order area for ordering a printout of the original digital content.

4. The system according to claim 3, wherein said content management server has a fifth transmitting unit, which is responsive to receipt of data transmitted from said client computer indicating that the order area has been clicked, for transmitting, to said client computer, data for displaying a window for inputting order information.

5. A method of controlling operation of a content management server that is capable of communicating with a client computer and a Web page server, said method comprising the steps of:
receiving original digital content transmitted from the client computer;
generating data for displaying a Web page, which includes a first section for acquiring part of the original digital content received, on a display unit of the client computer; and
transmitting the generated Web page data to at least one of the client computer and Web page server.

6. A method of controlling operation of a server system comprising a Web page server and a content management server capable of communicating with each other, said method comprising the steps of:
transmitting, from the Web page server to the client computer, data for displaying a Web page that includes a first section for obtaining part of original digital content and a second section for displaying a window that is for outputting substance represented by the original digital content;
transmitting the original digital content from the content management server to the client computer in response to data transmitted from the client computer indicating that the second section has been clicked; and
transmitting part of the original digital content from at least one of the Web page server and content management server to the client computer in response to receipt of data transmitted from the client computer indicating that the first section has been clicked.
